(19) United States
(12) Patent Application Publication
(10) Pub. No.: US 2022/0192924 A1
(43) Pub. Date: Jun. 23, 2022

(54) ADAPTIVE CAP DRILLING CLIP FOR MEDICAL BOTTLE

(71) Applicant: A RAYMOND ET CIE, Grenoble (FR)

(72) Inventors: Gaëtan Rey, Voiron (FR); Maxime Clavel, Vif (FR)

(21) Appl. No.: 17/542,127

(22) Filed: Dec. 3, 2021

(30) Foreign Application Priority Data
Dec. 23, 2020 (FR) 2014098

(51) Int. Cl. A61J 1/20

(52) U.S. Cl. CPC A61J 1/201; A61J 1/2096

(57) ABSTRACT

An adaptive clip is configured for piercing a stopper that closes a medical vial and is held so as to be assembled together with the vial by a cap. The clip comprises: a head that extends along a main plane and is provided, at its center and on an inner surface, with a cannula that ends in a point, the inner surface also being provided with at least one abutment for coming into contact with the stopper; a peripheral wall comprising a first end connected to the head of the clip and a second free end; and first tabs and second tabs formed in the peripheral wall, the first tabs each comprising a deformable tongue, and the second tabs being flexible and comprising notches on an inner face.

### CROSS-REFERENCE TO RELATED APPLICATION

Pursuant to 35 U.S.C. § 119(a), this application claims the benefit of the filing date of French Patent Application Serial No. FR2014098, filed Dec. 23, 2020, for “ADAPTIVE CAP DRILLING CLIP FOR MEDICAL BOTTLE.”

### TECHNICAL FIELD

The present disclosure relates to the field of medicine, and more particularly to that of withdrawals. It relates, in particular, to an adaptive clip for piercing a stopper for a medical vial, the stopper being held assembled on the vial by a cap. The clip is adaptive in that it can be used together with caps of different types and dimensions, in particular, height.

### BACKGROUND

In the field of medicine, it is conventional to use a stopper-piercing clip for accessing the contents of a vial closed by the stopper and withdrawing the medical solution stored in the vial. The stopper of the vial is typically held in position by a cap provided with a central opening for exposing a central portion of the stopper and enabling the piercing thereof. A cannula ending in a point is formed on the inner surface of the clip in order to perforate the exposed portion of the stopper and access the contents of the vial. The cannula comprises, close to the end thereof, a slit that opens into the interior of the cannula, similarly to that of a medical needle. A syringe devoid of needle, the cannula of the clip replacing the needle of the syringe, can subsequently be assembled and/or screwed onto the clip in order to withdraw the contents of the vial.

A clip of this kind is known from the document EP1474201. The clip comprises deformable tabs, which allow it to be arranged on vials provided with caps of varied diameters, thus forming a clip that is adaptive in terms of diameter. However, this type of adaptive clip does not take into account the height differences, which may exist between different types of cap. There are mainly two types of caps on the market: the caps of the capsule type, typically made of aluminum, which represent 95% of existing caps, and the caps of the locking cap type, typically made of plastic material, which represent the remaining 5%. The caps of the locking cap type are formed of an assembly of a plurality of elements, as is illustrated, for example, in the document WO2011039004. The caps of the capsule type are formed of a single element, typically a sheet of aluminum having a thickness on the order of a few tenths of a millimeter, covering the stopper and the head of the vial. The caps of the locking cap type, in turn, are much bulkier, in particular, with respect to height, and can reach a total height of between 10 and 20 millimeters, depending on the dimensions of the vial, on account of the various elements of which it is made up.

Since the clips are provided with retention means for retaining the clip assembled on the cap, a clip is generally not suitable for being clipped onto different types of caps, more particularly onto caps of different heights. Indeed, since the retention means are intended to be clipped under the cap, the position thereof on the cap is thus dependent on the height of the cap. A conventional clip therefore generally cannot be used interchangeably on these two types of cap, while ensuring fixing of the clip to the cap.

Moreover, these two types of caps also exhibit a difference in thickness in the region of the portion of the cap partially covering the stopper. In the case of a cap of the capsule type, this is typically a thickness of between 1 and 5 tenths of a millimeter, i.e., the thickness of an aluminum sheet, while in the case of a cap of the locking cap type this thickness is typically between 2 and 6 mm.

This difference in thickness, in the region of the stopper, is disadvantageous for the conventional clips because it can result in different penetration of the cannula, depending on the type of cap, and may thus lead to differences in dead volume during the withdrawal. The dead volume corresponds to the volume of solution, which cannot be withdrawn, and which is thus lost during withdrawal. Indeed, since the liquid withdrawals are carried out by turning the vial, if the cannula penetrates too deeply there is thus a dead volume of solution, which cannot be withdrawn because it is located below the slit of the cannula. If the cannula does not penetrate enough, there may be risk of leaks or contamination, it being possible for a portion of the slit to extend beyond the stopper and to connect the inside of the vial with the outside thereof. It is desirable to preserve the same effectiveness of withdrawal, i.e., an equivalent dead volume as well as an absence of leakage, whether the clip is used on a cap of the capsule type or of the locking cap type.

In a general manner, the stoppers comprise a zone of reduced thickness in the center thereof, to optimize the withdrawals. The zone of reduced thickness forms the lowest point of the stopper when it is turned. Thus, if the point of the clip does not penetrate precisely in the region of this low point for the withdrawal, it will be impossible to recover the solution located there, no portion of the cannula, and thus of the slit, having access thereto.

It is thus desirable to have a stopper-piercing adaptive clip for a medical vial, which makes it possible to ensure the fixing of the clip to the cap, to optimize the dead volume, and to preserve the same performances, no matter whether the clip is used on a cap of the capsule type or of the locking cap type, the locking cap having a thickness in the region of the stopper, as well as a total height, which are greater than those of a cap of the capsule type.

### BRIEF SUMMARY

An aim of the present disclosure is that of proposing a stopper-piercing adaptive clip for a medical vial, which addresses all or some of the issues discussed above. It relates, in particular, to a clip which achieves similar performances on caps of the capsule type or of the locking cap type, while ensuring the fixing of the clip to the cap.

In view of achieving this aim, the object of the present disclosure present disclosure is to provide an adaptive clip for piercing a stopper closing a medical vial and held assembled on the vial by a cap, the cap comprising a central opening for exposing a central portion of the stopper, the clip being in the form of a cowling to be clipped onto the cap and comprising:
a head extending according to a main plane and provided, in the center thereof and on an inner surface, with a cannula, which terminates in a point, the point being intended to pierce the central portion of the stopper to access the contents of the vial;
a peripheral wall comprising a first end that is connected to the head of the clip, and a second free end; and
separate first tabs and second tabs formed in the peripheral wall, the first tabs each comprising a deformable tongue, which extends radially from an inner face of the peripheral wall and oriented toward the head of the clip, and the second tabs being flexible and comprising notches on an inner face.

The adaptive clip is further notable in that the inner surface of the head comprises at least one abutment, which is intended to come into contact with the central portion of the stopper.

According to other advantageous and non-limiting features of the present disclosure, taken individually or in any technically possible combination:

the notches define a first plane oriented parallel with the main plane, and the deformable tongues define a second plane, which is different from the first plane, and is oriented parallel with the main plane, and is included between the point of the cannula and the first plane, the second plane being intended to form a contact plane with the cap during insertion of the clip onto the vial;
the at least one abutment is arranged at a distance from the cannula that is less than the radius of the central opening of the cap;
the at least one abutment is arranged at a distance of between 1 and 4 mm from the cannula;
the at least one abutment is of a height greater than or equal to 3.3 mm;
each of the first tabs is provided with a window on top of the deformable tongue for receiving the deformation thereof;
the deformable tongues are of a thickness of less than or equal to a thickness of the peripheral wall;
the adaptive clip is made of polycarbonate;
the notches have an inclined plane to promote the insertion of the clip onto the cap;
the head is provided, on an outer surface and in the extension of the cannula, with a joining element, which communicates with the cannula and allows for the connection of a needleless syringe, onto the clip in order to form a fluidic connection between the syringe and the vial.

According to another aspect, the present disclosure proposes an assembly comprising:
a vial;
a stopper closing the vial;
a cap holding the stopper assembled on the vial, the cap comprising a central opening for exposing a central portion of the stopper; and
an adaptive piercing clip according to the present disclosure, the clip piercing the stopper in the central portion thereof.

According to other advantageous and non-limiting features of the present disclosure, taken individually or in any technically possible combination:
the cap is of the capsule type and is of a height of the order of a tenth of a millimeter, and in which the deformable tongues are clipped onto the cap;
the cap is of the locking cap type and is of a height of approximately tens of millimeters, and in which:
   the deformable tongues bear against a circumferential wall of the locking cap;
   the notches of the second flexible tabs are clipped under the locking cap; and
the deformable tongues occupy the windows formed in the first tabs, at least in part.

### BRIEF DESCRIPTION OF THE DRAWINGS

Other features and advantages of the present disclosure will become clear from the following detailed description of embodiments of the present disclosure, with reference to the accompanying drawings, in which:

FIG. 1 is a view of the entirety of an adaptive clip according to the present disclosure;

FIGS. 2a and 2b are cross sections of an assembly including an adaptive clip according to the present disclosure assembled on a medical vial provided, respectively, with a cap of the capsule type and of the locking cap type, respectively;

FIG. 3 is a view from below of an adaptive clip according to the present disclosure; and

FIG. 4 is a hybrid cross section of a clip according to the present disclosure, the right-hand half of FIG. 4 being a cross section in the region of a deformable tongue, and the left-hand half being a cross section in the region of a notch.

### DETAILED DESCRIPTION

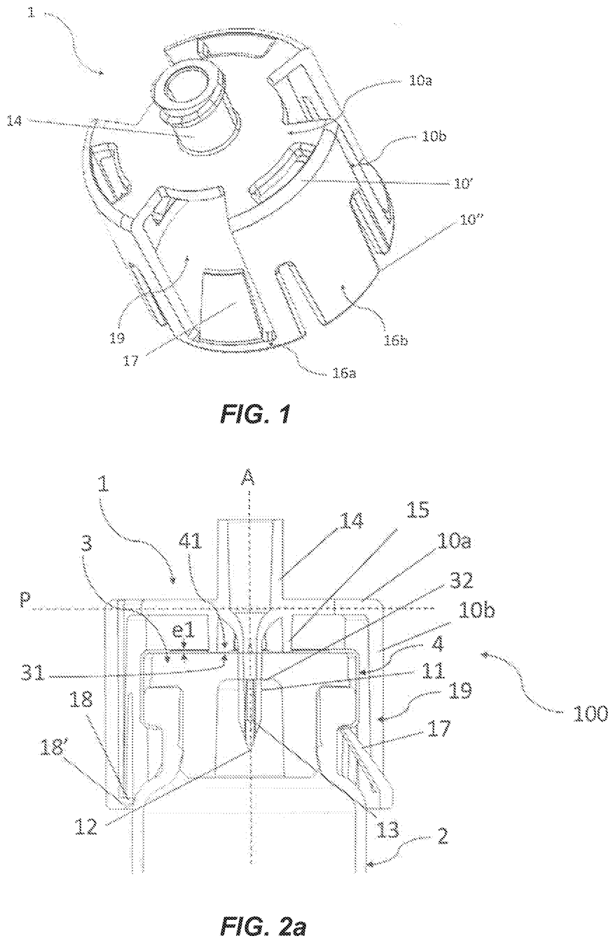

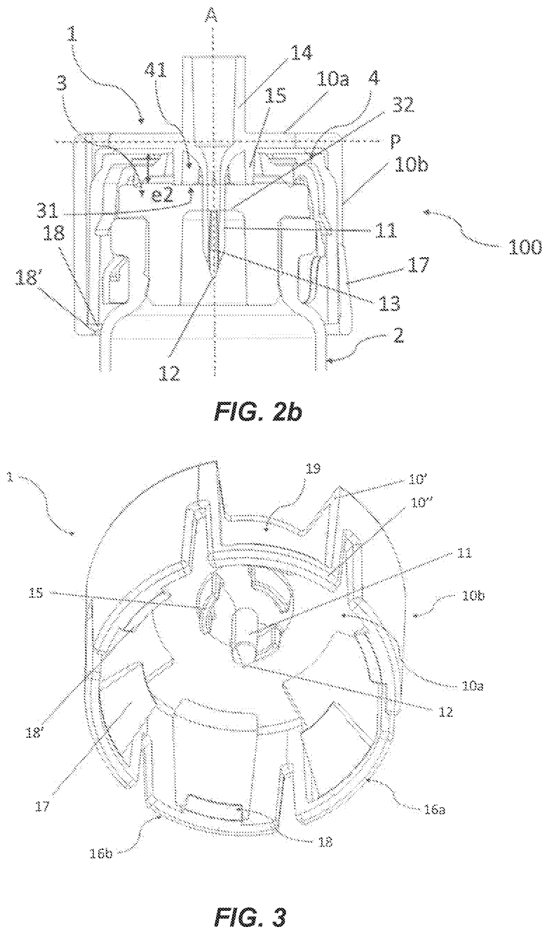

FIG. 1 is a view of the entirety of an adaptive clip 1 for piercing a stopper for a medical vial 2 (FIGS. 2a-2b), according to the present disclosure.

The medical vials 2 are closed by a stopper 3 (FIGS. 2a-2b) that is held assembled on the vial 2 by a cap 4. The cap 4 comprises a central opening 41, the size of which is typically between 5 and 10 mm, depending on the diameter of the vial, in order to expose a central portion 31 of the stopper 3. It will be noted that in the case of caps 4 of the locking cap type, these may comprise a capsule, which blocks access to the central opening 41, which is removed before using the adaptive piercing clip 1.

There are mainly two models of medical vials 2 on the market, depending on the solution volumes to be handled, the vials of a diameter of 13 mm, and those of a diameter of 20 mm, which are also of a greater height. In the remainder of the description, the numerical values applying to vials of 20 mm diameter will be given by way of example. The different numerical values can be adjusted without difficulty, particularly for vials of 13 mm diameter.

As has been previously described in the introduction, the stopper 3 comprises, in the center thereof, in the central portion 31, a zone of reduced thickness, forming the low point 32 of the stopper. It is generally formed of a material that can be easily pierced, such as rubber.

The cap 4, in turn, may be varied in nature, as has already been discussed; it may be a cap of the capsule type (FIG. 2a), typically formed of an aluminum sheet covering the stopper 3 as well as the head of the vial, or a locking cap (FIG. 2b) made up of a plurality of elements and covering the stopper 3 and the neck of the vial 2. The locking cap is of larger dimensions, in height and in thickness. Typically, in the case of a vial of 20 mm diameter, the height is between 14 and 20 mm. In the remainder of the description, the thickness of the part of the cap in contact with the upper face of the stopper 3 will be referred to by the expression “thickness e1, e2 of the top of the cap,” the thickness e1 of the top of a cap of the capsule type being less than that e2 of a cap of the locking cap type. As set out above in the background, the thickness e1 of caps of the capsule type is typically on the order of a tenth of a millimeter while, for the locking caps, this thickness e2 is on the order of a millimeter, for example, between 2 and 6 mm in the case of a vial of 20 mm diameter.

FIGS. 2a and 2b are cross sections of an assembly 100 that includes an adaptive clip 1 assembled on a medical vial 2 provided, respectively, with a cap of the capsule type and of the locking cap type.

The adaptive clip 1 is formed of a plastic material, such as polycarbonate.

The adaptive clip 1 is in the form of a cowling to be inserted and to clip onto the cap 4. The clip 1 comprises a head 10a as well as a lateral wall 10b, which is cylindrical in shape so as to surround the cap 4.

The head 10a extends according to a main plane P and is provided, in the center thereof and on an inner surface, with a cannula 11, which terminates in a point 12 intended to pierce the stopper 3 of the vial 2. The “inner surface” means the surface that is intended to come to face or to come into contact with the cap 4 of the medical vial 2. The head 10a also comprises, arranged on the inner surface thereof (FIG. 3), at least one abutment 15, which is intended to come into contact with the central portion of the stopper 3 in order to control the penetration of the cannula 11 through the stopper 3, coming into abutment against the stopper 3, as is clearly visible in FIGS. 2a and 2b.

As shown in FIG. 1, the peripheral wall 10b comprises a first end 10′ that is connected to the head 10a of the clip 1, and a second end 10″. First and second tabs 16a, 16b are separate and delimited by grooves, which are formed on the peripheral wall 10b and open in the region of the second end 10″. Thus, each tab 16a, 16b presents a free end, on the side of the second end 10″ of the peripheral wall 10b. The first tabs 16a and the second tabs 16b are arranged alternately around the perimeter of the wall 10b. In other words, each first tab 16a is next to two second tabs 16b, and each second tab 16b is next to two first tabs 16a. The first tabs 16a each comprise a deformable tongue 17, which extends radially from an inner face of the peripheral wall 10b and is oriented toward the head 10a of the clip 1. The second tabs 16b are flexible and in turn comprise notches 18 on the inner face thereof. Of course, it is also possible for the peripheral wall 10b to comprise third tabs, separate from the first and second tabs, which do not comprise any deformable tongue 17 or notch 18, but contribute to forming the cylindrical peripheral wall of the clip 1. Of course, the first tabs 16a, or indeed the third tabs, can also be flexible. The figures show three first tabs 16a and three second tabs 16b. Nonetheless, these numbers of tabs are not restrictive, and it is entirely possible to have a different number, in particular, depending on the diameter of the vial, such as four or two tabs of each type.

FIG. 3 is a view from below of a clip 1 according to the present disclosure, in order to illustrate the inner surface of the head 10a of the clip 1.

In this case, three abutments 15 are shown in the form of ribs arranged on either side of the cannula 11 according to a circle having the cannula 11 as the center. Of course, the number of abutments 15 as well as their type may vary, and the present disclosure is in no way limited to the example shown. For example, it is possible to have just one single abutment 15 in the form of an annular groove, which entirely surrounds the cannula 11, or a shoulder, or indeed to have four contacts arranged on either side of the cannula 11. In any case, it is important that the (at least one) abutment 15 should be arranged at a distance from the cannula 11 that is less than the radius of the central opening 41 of the cap 4, for example, less than a distance of 4.2 mm in the case of a vial of 20 mm diameter, in order to be able to pass through the central opening 41 and come to abut the exposed central portion 31 of the stopper 3. The abutments 15 are advantageously arranged at a distance from the cannula 11 of between 1 and 4 mm. The height of the abutments 15 is determined so as to be greater, by a few tenths of a millimeter, than, or equal to, the thickness e2 of the head of a cap 4 of the locking cap type in order to control the penetration of the cannula 11 through the stopper 3, such that it is identical whatever the type of cap used. In particular, the height of the abutments 15 is generally greater than or equal to 3.3 mm in the case of a vial of 20 mm diameter.

The cannula 11 extends according to a central axis A, which is perpendicular to the main plane P. The cannula 11 is hollow and comprises, close to the point 12 thereof, a slit 13, which opens inside the cannula 11 in order to allow for suction, via the cannula 11, of the medical solution contained in the vial 2. The length of the cannula 11 is defined, taking into account the existence of the abutments 15, so as to be able to expose the slit 13 of the cannula 11 inside the vial 2 without a portion of the slit 13 opening outside the vial 2, in order to avoid leaks. It is also possible to adjust the dimensions of the slit 13 in order to arrive at this result, the main consideration being that no portion of the slit 13 should open outside the vial 2, and that at least a portion of the slit 13 should open inside the vial, preferably as close as possible to the inner surface of the stopper 3 in order to limit the dead volumes. The dimensions of the portion of the slit 13 that is exposed inside the vial 2 determine the suction speed; the larger this exposed portion, the greater the suction, and thus the withdrawal speed, will be.

The head 10a of the clip 1 comprises, on the outer surface thereof, in the extension of the cannula 11, a joining element 14, which communicates with the inside of the cannula 11, in order to allow the connection of a syringe devoid of needle (not shown in the figures) onto the clip 1. The joining element 14 thus forms a fluidic connection between the syringe and the vial 2 in order to transfer the contents of the medical vial 2 toward the syringe. In order to allow for the connection to the syringe, the joining element 14 may comprise an internal or external thread for interacting with a complementary thread on the syringe, and/or may have a particular geometry, such as a shoulder, for allowing for clipping of the syringe. The connection of the syringe to the clip 1 may also be simple cone-on-cone wedging.

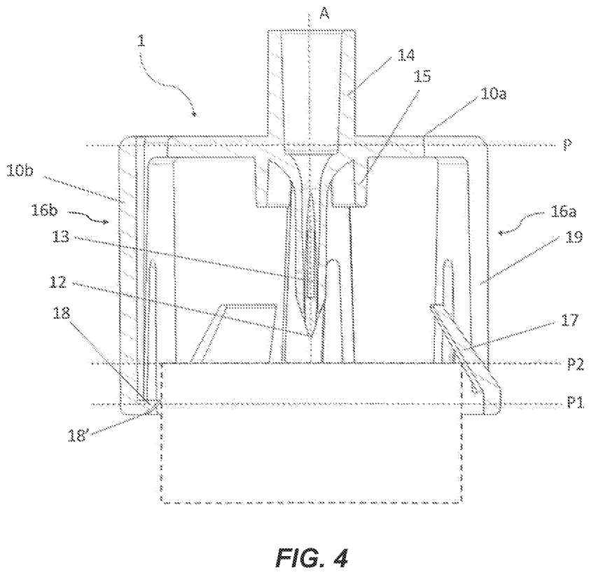

FIG. 4 is a hybrid cross section of a clip according to the present disclosure, the right-hand half of FIG. 4 being a cross section in the region of a flexible tongue 17, and the left-hand half being a cross section in the region of a notch 18.

Advantageously, the first tabs 16a comprise a window 19 on top of the deformable tongue 17 for receiving the deformation thereof. In a manner that is also advantageous, the thickness of the tongues 17 is selected so as to be less than or equal to the thickness of the peripheral wall 10b, in order to prevent the tongues 17 from projecting too much beyond the wall 10b, through the window 19, during the deformation thereof. This is typically a thickness of between 0.5 and 2 mm. In the case of a cap of the capsule type, the tongues 17 are intended to be clipped under the cap 4, and more particularly under the neck of the vial 2, in order to retain the clip 1 assembled on the cap 4. In the case of a cap 4 of the locking cap type, the tongues 17 are intended to flatten and come into contact against the peripheral wall of the cap 4, while occupying the windows 19, at least in part. The tongues 17 are initially inclined, and the inner surface thereof thus defines frustoconical surface portions.

The notches 18 are advantageously arranged so as to be close to the second end 10″ of the flexible second tabs 16b and at a distance from the head 10a that is greater than or equal to the height of a cap 4 of the locking cap type, i.e., typically greater than or equal to 17 mm in the case of a vial of 20 mm diameter. The notches 18 also have a radial dimension that is selected such that the radial distance between the central axis A and the notches 18 is less than the radius of a cap of the locking cap type, in order to allow for the notches to clip under the cap 4 (see FIG. 2b). Advantageously, the notches 18 have a radial dimension that is such as to have a catch of at least 0.5 mm, once clipped under the cap 4, i.e., for example, a radial dimension of between 0.75 and 1.75 mm in the case of a vial of 20 mm diameter.

In a manner that is also advantageous, the radial dimension of the notches 18 can be selected such that the radial distance between the central axis A and the notches 18 is less than the radius of a cap 4 of the capsule type, in order that the notches 18 can also come into contact against this type of cap during the insertion of the clip 1. The notches 18 advantageously have an inclined plane 18′ so as to promote the insertion of the clip 1 onto the cap 4 by guiding the deformation of the flexible second tabs 16b. The fact that the notches 18 are formed on flexible elements, in this case on the second tabs 16b, makes it possible for the clip 1 to be inserted onto the cap 4. Indeed, in the absence of this flexible character, the notches 18 would come into abutment against the cap 4 without the possibility of deforming in order to spread apart and thus allow for the insertion of the clip 1 onto the cap 4.

The notches 18 define a first plane P1 in parallel with the main plane P, and the deformable tongues 17 define a second plane P2, which is different from the first plane P1, is also in parallel with the main plane P, and is intended to form a contact plane with the cap 4 during insertion of the clip 1 onto the vial 2 as is shown in FIG. 4 (the vial equipped with the stopper 3, and the cap 4 thereof, being shown schematically by the rectangle defined by dotted lines). The second plane P2 corresponds to the first intersection between the frustoconical surface formed by the tongues 17 and a disc having a radius equal to that of the cap 4 and in parallel with the main plane P according to the direction of insertion of the clip 1 onto the cap 4.

The deformable tongues 17 also have a role of centering the clip 1 during insertion thereof on to the cap 4, in particular, in the case of a cap 4 of the capsule type. Indeed, since the caps 4 of the capsule type have a diameter that is less than that of the caps of the locking cap type, a clearance of the order of several millimeters (FIG. 2a), typically between 1 and 5 mm, exists between the peripheral wall 10b of the clip and the cap 4. There is a non-negligible risk, for this type of cap 4, of incorrect centering of the clip 1, and thus of not piercing the stopper 3 in the region of the low point 32 thereof, leading to an increase in the dead volume for the withdrawal.

In order to implement this centering role, the tongues 17 are designed, by virtue of the length thereof and the initial inclination thereof, such that the plane of contact with the cap 4, during insertion of the clip 1 onto the vial 2, is achieved at the same time as, or preferably before, the contact of the point 12 of the cannula 11 with the stopper 3. In other words, the second plane P2 is included between the first plane P1 and the point 12 of the cannula 11. Advantageously, as has been described above, the radial dimension of the notches 18 can be selected such that contact can be achieved between the notches 18 and a cap 4 of the capsule type for achieving pre-centering of the clip 1 on the cap 4, before the cap 4 comes into contact with the tongues 17 in the region of the second plane P2.

Depending on whether the adaptive clip 1 is used on a cap 4 of the capsule type or of the locking cap type, different interactions will take place during the insertion of the clip 1 onto the cap 4, in particular, in the region of the tongues 17 and of the notches 18.

The case of the cap 4 of the locking cap type (FIG. 2b) will be addressed first, before addressing the case of the cap of the capsule type (FIG. 2a).

First, during the insertion of the clip 1 onto the cap 4, the notches 18 come into contact against the cap 4 in the region of the first plane P1. The inclined plane 18′ makes it possible to facilitate the insertion of the clip 1 onto the cap 4 by guiding the deformation of the flexible second tabs 16b, and also contribute to the centering of the clip 1 on the cap 4, and consequently to the centering of the clip 1 on the stopper 3.

Second, the deformable tongues 17 come into contact against the cap 4, in the region of the second plane P2, and deform in the windows 19 so as to flatten against the wall of the cap 4.

Third, while the deformable tongues 17 continue their deformation, the point 12 of the cannula 11 comes into contact with the exposed central portion 31 of the stopper 3 and pierces the stopper 3 at the low point 32 thereof, by virtue of the centering achieved by the notches 18 and the tongues 17.

Finally, the clip 1 continues its penetration onto the cap 4, the abutments 15 pass through the central opening 41 of the cap 4 until they come to bear against the central portion 31 of the stopper 3. The notches 18 fold under the cap 4 simultaneously with or slightly before the contact between the abutments 15 and the stopper 3. The clip 1 is thus retained in a rigid manner, assembled on the cap 4, and the stopper 3 pierced in the center thereof. A syringe can then be assembled on the clip 1 in order to achieve the withdrawal.

The case of the cap 4 of the capsule type (FIG. 2a) will now be addressed.

First, depending on the radial dimension of the notches 18, the notches 18 can, similarly to the case of a cap 4 of the locking cap type, come into contact and deform with the cap 4 in the region of the first plane P1, and make it possible to carry out pre-centering of the clip 1 on the cap 4, before the contact between the tongues 17 and the cap 4.

Second, the deformable tongues 17 come into contact against the cap 4, in the region of the plane P2, before or simultaneously with the contact between the point 12 of the cannula 11 and the stopper 3, in order to center the clip 1 on the cap 4 and thus on the stopper 3 before piercing it. The tongues 17 then deform progressively in the windows 19 in order to authorize the passage of the cap 4.

Third, possibly simultaneously with the second step, the point 12 of the cannula 11 comes into contact with the exposed central portion 31 of the stopper 3 at the low point 32 thereof, by virtue of the centering achieved by the tongues 17 and optionally the notches 18, in order to pierce it in the center thereof. The tongues 17 continue to deform in the windows 19 in order to allow for the passage of the cap 4, while the cannula 11 passes through the stopper 3.

Finally, the clip 1 continues its penetration onto the cap 4, the abutments 15 pass through the central opening 41 of the cap 4 until they come to bear against the central portion 31 of the stopper 3, and the tongues 17 return into position in order to be received under the cap 4, simultaneously with or slightly before the contact between the abutments 15 and the stopper 3. The clip 1 is thus retained in a rigid manner, assembled on the cap 4, and the stopper 3 pierced in the center thereof. A syringe can then be assembled on the clip 1 in order to achieve the withdrawal.

By virtue of the presence of abutments 15, the same penetration of the cannula 11 through the stopper 3, and thus the same suction and dead volume parameters, are maintained, no matter the type of cap 4 used, for one clip 1. By virtue of the presence of the tongues 17 and the notches 18, it is also ensured that the stopper 3 is pierced at the low point 32 thereof for optimal withdrawal, and these elements 17, 18 furthermore make it possible to ensure good retention of the clip 1 on the cap 4, whatever the type of cap used for one clip.

Of course, the present disclosure is not limited to the embodiment(s) described, and it is possible to add variants thereto, without extending beyond the scope of the invention as defined by the claims.

Although in this case only the numerical values for medical vials of 20 mm diameter have been indicated, it is noted that these numerical values can easily be adjusted, without departing from the scope of the present disclosure, so as to be used for medical vials of 13 mm or 32 mm diameter, or any other non-standardized diameter.

1. An adaptive clip for piercing a stopper closing a medical vial and held so as to be assembled together with the vial by a cap, the cap having a central opening for exposing a central portion of the stopper, the clip having a shape of a cowling to clip onto the cap, and the adaptive clip comprising:
a head extending along a main plane and provided, at its center and on an inner surface, with a cannula ending in a point, the point being configured to pierce the central portion of the stopper to access the contents of the vial, the inner surface of the head comprising at least one abutment intended to come into contact with the central portion of the stopper;
a peripheral wall comprising a first end connected to the head of the clip and a second free end; and
first tabs and second tabs separate and formed in the peripheral wall, the first tabs each comprising a deformable tongue that extends radially from an inner face of the peripheral wall and is oriented toward the head of the clip, and the second tabs being flexible and comprising notches on inner faces of the second tabs.

2. The clip of claim 1, wherein the notches define a first plane parallel to the main plane and the deformable tongues define a second plane different from the first plane, the second plane oriented parallel to the main plane and located between the point of the cannula and the first plane, the second plane intended to form a plane of contact with the cap when the clip is inserted on the vial.

3. The clip of claim 2, wherein the at least one abutment is arranged at a distance from the cannula that is less than a radius of the central opening in the cap.

4. The clip of claim 3, wherein the at least one abutment is arranged at a distance of between 1 mm and 4 mm from the cannula.

5. The clip of claim 4, wherein the at least one abutment has a height greater than or equal to 3.3 mm.

6. The clip of claim 5, wherein each of the first tabs has a window above the deformable tongue in order to allow the deformation of the tongue.

7. The clip of claim 6, wherein the deformable tongue has a thickness that is less than or equal to a thickness of the peripheral wall.

8. The clip of claim 7, wherein the clip comprises polycarbonate.

9. The clip of claim 1, wherein the notches have an inclined plane to facilitate insertion of the clip on the cap.

10. The clip of claim 1, wherein the head is provided, on an outer surface and in the extension of the cannula, with a joining element in communication with the cannula and allowing a needleless syringe to be connected to the clip to produce a fluidic connection between the syringe and the vial.

11. An assembly, comprising:
a vial;
a stopper closing the vial;
a cap holding the stopper so as to be assembled together with the vial, the cap having a central opening for exposing a central portion of the stopper; and
an adaptive piercing clip according to claim 1, the clip configured to pierce the stopper in the central portion of the stopper.

12. The assembly of claim 11, wherein the cap is a capsule cap and has a height of approximately a tenth of a millimeter, and wherein the deformable tongues clip under the cap.

13. The assembly of claim 11, wherein the cap is a locking cap and has a height of approximately tens of millimeters and wherein:
the deformable tongues abut a circumferential wall of the locking cap; and
the notches of the second tabs are clipped under the locking cap.

14. The assembly of claim 13, wherein the deformable tongues at least partially occupy windows formed in the first tabs.

15. The clip of claim 1, wherein the at least one abutment is arranged at a distance from the cannula that is less than a radius of the central opening in the cap.

16. The clip of claim 15, wherein the at least one abutment is arranged at a distance of between 1 mm and 4 mm from the cannula.

17. The clip of claim 1, wherein the at least one abutment has a height greater than or equal to 3.3 mm.

18. The clip of claim 1, wherein each of the first tabs has a window above the deformable tongue in order to allow the deformation of the tongue.

19. The clip of claim 1, wherein the deformable tongue has a thickness that is less than or equal to a thickness of the peripheral wall.

20. The clip of claim 1, wherein the clip comprises polycarbonate.
